(19) United States
(12) Patent Application Publication
(10) Pub. No.: US 2015/0343457 A1
(43) Pub. Date: Dec. 3, 2015

(54) Filtering Apparatus for Controlling High Voltage Transformer with Printed Circuit Board

(71) Applicant: NIT KOREA CO., LTD, Gyeonggi-do (KR)

(72) Inventor: So-young Jeon, Seoul (KR)

(21) Appl. No.: 14/576,753

(22) Filed: Dec. 19, 2014

(30) Foreign Application Priority Data
May 31, 2014 (KR) 10-2014-0066588

(51) Int. Cl. B03C 11/00; B03C 3/66; H01F 27/24; B03C 3/38; H01F 27/02; H01F 27/28

(52) U.S. Cl. CPC B03C 11/00; H01F 27/02; H01F 27/28; H01F 27/24; B03C 3/38; B03C 3/66

(57) ABSTRACT

Provided is a dust collector having a high voltage transformer controlled by a printed circuit board (PCB), and more particularly, a dust collector having a high voltage transformer controlled by a PCB, wherein precipitation performance is improved while the high voltage transformer is controllable by the PCB. The dust collector includes a control module and a precipitation filter. The control module includes: a transformer module including a core having a pair of magnetic flux paths formed to contact each other, a second coil unit into which one of the pair of magnetic flux paths is inserted, and a first coil unit having a cylindrical shape to accommodate the second coil unit; a housing having a separated space in which the transformer module is accommodated; a PCB module disposed in another space of the housing; and a separation plate that separates the transformer module and the PCB module from each other.

### CROSS-REFERENCE TO RELATED APPLICATION

This application claims priority under 35 USC 119(a) to Korean Application No. 10-2014-0066588, filed on May 31, 2014, the disclosure of the prior application being incorporated herein in its entirety by reference in the disclosure of this application.

### BACKGROUND

1. Field

One or more embodiments of the present invention relate to a dust collector having a high voltage transformer controlled by a printed circuit board (PCB), and more particularly, to a dust collector having a high voltage transformer controlled by a PCB, wherein precipitation performance is improved while the high voltage transformer is controllable by the PCB.

2. Description of the Related Art

An electric dust collector is an apparatus for collecting dust that is electrified in a negative charge or a positive charge by using a positive electrode as a collecting electrode and a negative electrode as a discharge electrode. Generally, dust or a gas electrified by generating a non-uniform electric field via a corona discharge obtained by applying a high voltage between the collecting electrode and the discharge electrode is collected by using an electrostatic force of the collecting electrode. The electric dust collector may be used generally in large workshops where dust or gases are largely generated, as well as in places of business where dust or fine foreign substances are generated. Methods of charging, by the electric dust collector, dust or micro-particles may be classified into a direct current (DC) charge voltage method and a micro-pulse charging method based on how a high voltage, for example, from 30 to 100 kV, is applied.

Since a high voltage is applied to the collecting electrode or the discharge electrode of the electric dust collector, a transformer that stably generates the high voltage while having durability is required. Also, the collecting electrode and the discharge electrode need to be protected if a micro-pulse voltage is applied to a charging source, and a form of the micro-pulse voltage may be suitably adjusted according to specific resistance or flow of micro-particles.

### SUMMARY

According to one or more embodiments of the present invention, a dust collector includes a control module and a precipitation filter, wherein the control module includes: a transformer module including a core having a pair of magnetic flux paths formed to contact each other, a second coil unit into which one of the pair of magnetic flux paths is inserted, and a first coil unit having a cylindrical shape to accommodate the second coil unit; a housing having a separated space in which the transformer module is accommodated; a printed circuit board (PCB) module disposed in another space of the housing; and a separation plate that separates the transformer module and the PCB module from each other.

The dust collector may further include a pair of terminal units having a curved shape formed at the first coil unit, wherein the pair of terminal units may have a wire arrangement structure for accommodation and electric connection of components connected to the pair of terminal units.

The precipitation filter comprises a resonance circuit and an inductor for operating in a micro-pulse voltage method, and a generating cycle of the resonance is determined by a micro-particle charging sensor, wherein a charging voltage for the resonance circuit is variable.

### BRIEF DESCRIPTION OF THE DRAWINGS

These and/or other aspects will become apparent and more readily appreciated from the following description of the embodiments, taken in conjunction with the accompanying drawings in which:

FIGS. 1, 2, 3A and 3B are diagrams of a transformer module applicable to a dust collector, according to an embodiment of the present invention;

FIG. 4 is a diagram of a control module for controlling a dust collector, according to an embodiment of the present invention;

FIGS. 5A and 5B are diagrams of a precipitation filter applicable to a dust collector, according to an embodiment of the present invention; and

FIGS. 6 and 7 are diagrams for describing an operational structure of a dust collector, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Well-known components are simply described or not described, but should not be construed as being excluded from one or more embodiments of the present invention.

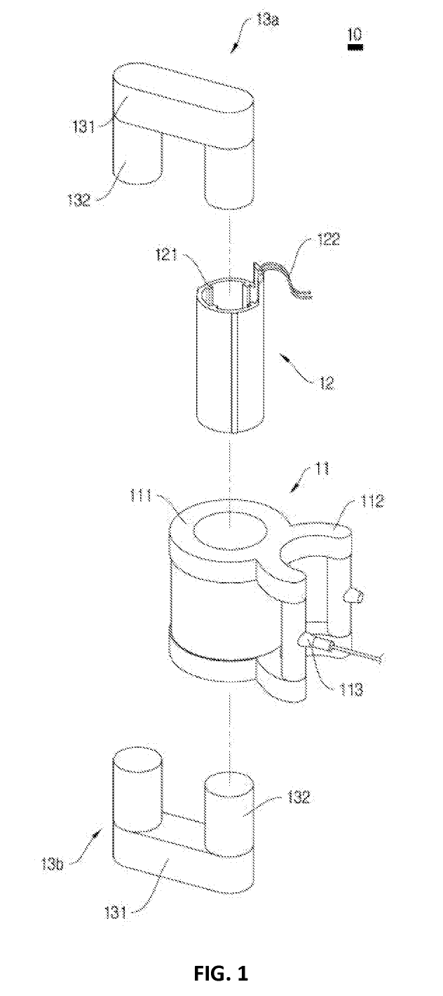

FIGS. 1, 2, 3A and 3B are diagrams of a transformer module 10 applicable to a dust collector, according to an embodiment of the present invention.

The dust collector according to an embodiment of the present invention includes a control module and a precipitation filter, wherein the control module includes the transformer module 10 including core 13a and 13b having a pair of magnetic flux paths 132 formed to contact each other, a second coil unit 12 into which one of the pair of magnetic flux paths 132 is inserted, and a first coil unit 11 having a cylindrical shape to accommodate the second coil unit 12; a housing having a separated space in which the transformer module 10 is accommodated; a printed circuit board (PCB) module disposed in another space of the housing; and a separation plate that separates the transformer module 10 and the PCB module from each other.

The transformer module 10 will now be described in detail.

Referring to FIGS. 1, 2, 3A and 3B, the transformer module 10 applied to the dust collector including the control module and the precipitation filter may include: the cores 13a and 13b having the pair of magnetic flux paths 132 formed to contact each other; the second coil unit 12 into which one of the pair of magnetic flux paths 132 is inserted; and the first coil unit 11 having a cylindrical shape in which the second coil unit 12 is accommodated.

The transformer module 10 may change a charging voltage, a collecting voltage, or a current applied to a collecting electrode or a discharge electrode. The transformer module 10 according to an embodiment of the present invention may change an alternating current (AC) voltage of a high frequency received from a power source and transmit the changed AC voltage to a rectifier 15.

The cores 13a and 13b may form a magnetic flux channel, and for example, may include the pair of magnetic flux paths 132 having a cylindrical shape and a connection path 131 connecting one ends of the pair of magnetic flux paths 132 to each other. The cores 13a and 13b may be formed of a well-known arbitrary core material, such as non-oriented steel manufactured from silicon steel or iron powder, an iron-nickel alloy, or a cobalt-iron-vanadium material, but a material of the cores 13a and 13b is not limited thereto. The cores 13a and 13b may form a pair and may be disposed to face each other. In detail, the ends of the magnetic flux paths 132 of the cores 13a and 13b may contact each other. The magnetic flux path 132 and the connection path 131 may be integrally formed of the same material, and the cores 13a and 13b may be formed of the same or similar material in the same or similar structure.

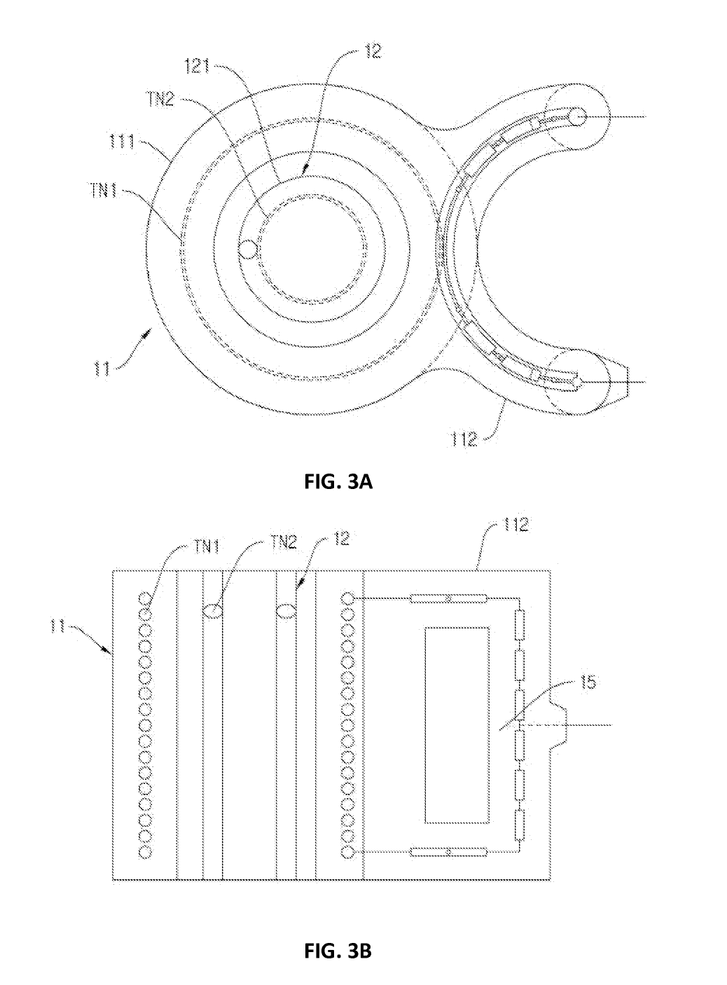

A coil may be formed inside the first and second coil units 11 and 12. Referring to FIGS. 3A and 3B, a first coil TN1 may be disposed in the first coil unit 11 and a second coil TN2 may be disposed in the second coil unit 12. The first and second coils TN1 and TN2 may have a turns ratio according to a transformation condition, wherein the turns ratio may be suitably set according to a ratio of voltage applied to the power source and the precipitation filter. The first coil unit 11 may have a cylindrical shape having an insertion path at a center portion in a length direction, and the second coil unit 12 may have a hollow cylindrical shape. Also, a coil be wound around a circumferential surface of each of the first and second coil units 11 and 12, and after the coil is wound, the circumferential surface may be, for example, coated with synthetic resin, such as epoxy, for insulation. If required, an epoxy insulator may be filled into the first and second coil unit 11 and 12. In detail, the first and second coil units 11 and 12 may each be formed of an insulating material, such as an inorganic material or a synthetic resin material. Also, if required, the inorganic material or the synthetic resin material may include an anticorrosive material. Also, an inner region and an outer region of each of the first and second coil units 11 and 12 may be formed of different materials. For example, the inner and outer regions may be both formed of an insulating material, while the outer region is formed of a material that has relatively high thermal conductivity. Alternatively, an outer surface of the first or second coil unit 11 or 12 may be coated with a material having high thermal conductivity.

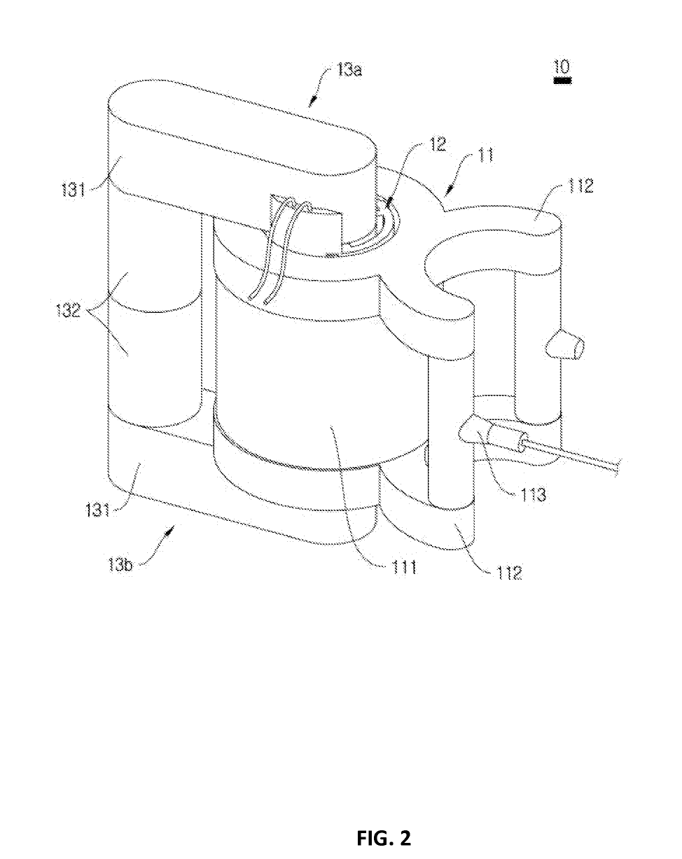

As shown in FIG. 2₁ the second coil unit 12 may be inserted into the insertion path formed in the first coil unit 11, and the cores 13a and 13b may be respectively combined to the bottom and top of a path formed at the center of the second coil unit 12.

Such a structure reduces a thermal loss while maintaining a uniform transformation state regardless of a running time. In addition, since the first and second coils TN1 and TN2 are disposed inside the first and second coil units 11 and 12 while being completely sealed, the first and second coils TN1 and TN2 are prevented from being contaminated and damaged. Moreover, a breakdown voltage may be increased and a high voltage is stably generated at a high temperature.

A pair of terminal units 112 may be further formed on the circumferential surface of the first coil unit 11. The pair of terminal units 112 may each have a handle structure, and may be disposed to face each other. In detail, the terminal unit 112 has a wire arrangement structure for accommodating and electrically connecting components. A connection terminal 113 may be formed at a suitable location of the terminal unit 112. The connection terminal 113 may electrically connect the first coil unit 11 to another component. For example, referring to FIGS. 3A and 3B, the terminal units 112 may have an overall structure of enfolding each other, and for example, may have a structure for fixing the rectifier. Also, a wire may be formed inside two ends of the first coil TN1 to be connected to the rectifier 15 or the connection terminal 113. Meanwhile, the second coil TN2 of the second coil unit 12 may be electrically connected to an external component, such as a power source, by an external wire 122 formed outside a coil body 121. Alternatively, a cover may be formed on the transformer module 10, and the external wire 122 may be formed inside the cover. The external wire 122 may be formed in any one of various methods, and is not limited to one or more embodiments of the present invention.

According to an embodiment of the present invention, the transformer module 10 may be disposed inside the control module.

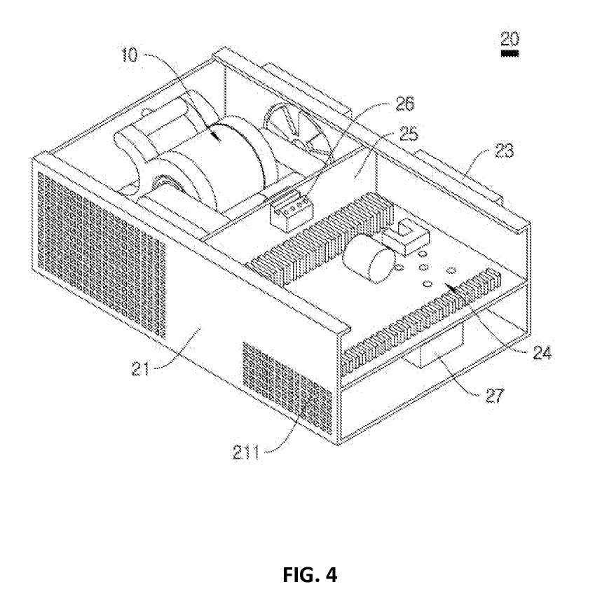

FIG. 4 is a diagram of a control module 20 for controlling a dust collector, according to an embodiment of the present invention.

Referring to FIG. 4, the control module 20 may include a housing 21, a separation plate 25 that separates the housing 21 into two separated spaces, the transformer module 10 accommodated in one of the separated spaces, and a PCB module 24 disposed in the other separated space.

The transformer module 10 may have the same or similar structure as the one described above, and the PCB module 24 may have a structure capable of controlling an overall dust collector by including a microprocessor. The transformer module 10 and the PCB module 24 may be separated by the separation plate 25 formed of an insulating material, and may be electrically connected to each other by a connector 26 combined to the separation plate 25. As such, the transformer module 10 and the PCB module 24 are separated from each other by the separation plate 25 so that, for example, the transformer module 10 and the PCB module 24 are not affected by heat or moisture, and at the same time, by a magnetic field or electromagnetic waves. As occasion demands, the separation plate 25 may be formed of an electromagnetic wave absorbing material, may accommodate an electromagnetic wave absorbing material therein, or may be coated with an electromagnetic wave absorbing material. As such, the separation plate 25 electrically separates the transformer module 10 and the PCB module 24 from each other while making environmental conditions of the transformer module 10 and the PCB module 24 to be independent from each other. A radiating hole may be provided outside the housing 21, and a pan unit 23 for radiating, cleaning, and dehumidifying the transformer module 10 and the PCB module 24 may be provided. There may be at least two pan units 23. As occasion demands, a protection unit 27 may be provided below the PCB module 24, and for example, the protection unit 27 may be a switch protection circuit.

The control module 20 shown in FIG. 4 may enable the transformer module 10 and the PCB module 24 to stably operate while enabling the dust collector to be modularized. The control module 20 may be separately manufactured and provided from a precipitation filter. Also, since an overall operation of the dust collector is controlled by the control module 20, an operational structure of the dust collector may be simplified.

The control module 20 according to an embodiment of the present invention may be operated according to a micro-pulse charging control method, and for example, may be set to have a voltage range from 15 kV to 18 kV or an applied current from 10 mA to 60 mA, but is not limited thereto. The transformer module 10 may be an epoxy transformer module having an insulating structure formed of epoxy resin. The control module 20 may be operated according to a program logic control (PLC) method by the PCB module 24. Such a PLC method enables modularization of the control module 20. The transformer module 10 and the PCB module 24 enable a stable voltage increase, and as an epoxy high tension insulator is inserted into the transformer module 10, the transformer module 10 stably operates at a high temperature condition. As occasion demands, a power source block circuit, an overvoltage protective circuit, a temperature protective circuit for a high-tension transformer, and an operation check circuit may be provided. The transformer module 10 may use a variable method, and accordingly, an adjusting switch for adjusting a number of coils of a first or second coil unit may be provided. A main circuit of the PCB module 24 may have a high frequency inverter topology, and a high intensity opto-coupler may be used as a switching device. For example, when an operating frequency may be set from 20 kHz to 80 kHz, a current continuous adjusting range may be set from 10 mA to 80 mA, an operating voltage range may be set from 10 kV to 20 kV, and a maximum output may be set to 1600 W. However, operating conditions are not limited thereto. Also, the control module 20 according to an embodiment of the present invention may be operated according to a micro-pulse charging method as described below such that a back current phenomenon is prevented.

The control module 20 according to an embodiment of the present invention may be operated according to any one of various methods, and is not limited.

Hereinafter, a precipitation filter connectable to the control module 20, according to an embodiment of the present invention, will be described.

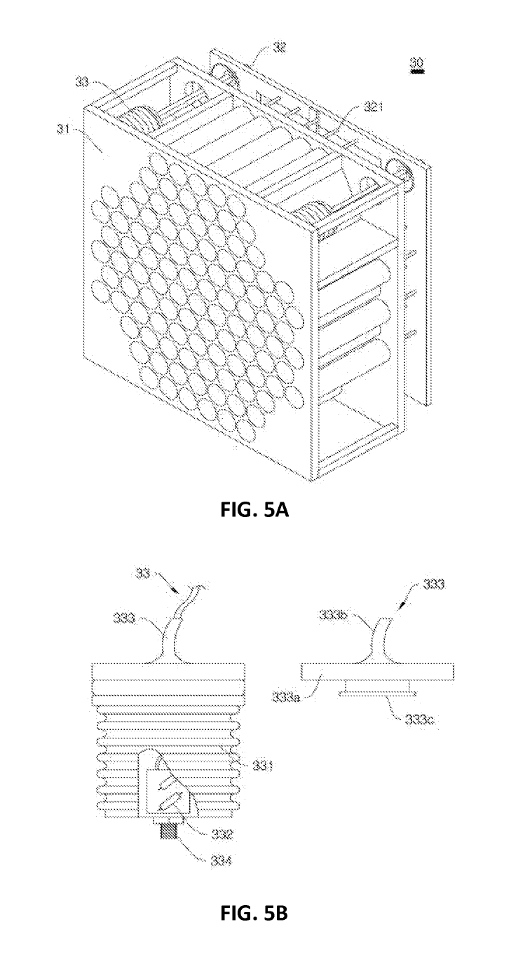

FIGS. 5A and 5B are diagrams of a precipitation filter 30 applicable to a dust collector, according to an embodiment of the present invention.

FIG. 5A is a diagram of the precipitation filter 30 applicable to a dust collector, according to an embodiment of the present invention, and FIG. 5B is a diagram of an insulating unit 33 disposed in the precipitation filter 30.

Referring to FIG. 5A, the precipitation filter 30 may include a precipitation unit 31, a discharging unit 32 having a discharge bar extending into the precipitation unit 31, and the insulating unit 33 that electrically insulates the precipitation unit 31 and the discharging unit 32 from each other.

The precipitation unit 31 may include a plurality of precipitation cells having a hollow cylindrical shape, and a fixing plate for fixing the precipitation cells. The fixing plate may have a structure for fixing the top and bottom of the precipitation cell, and the precipitation cell may have a structure for discharging dust received from one end to the other end while being fixed to the fixing plate. The number of precipitation cells is not limited, and the precipitation cells may be arranged in any form. In detail, the precipitation cells may be arranged in a dense structure having a beehive shape.

The discharging unit 32 induces a discharge according to a voltage difference with the precipitation unit 31, and may include a plurality of discharge bars that respectively extend into the precipitation cells and a fixing member that connects the plurality of discharge bars to each other. One end of the discharge bar may be disposed inside the precipitation cell and the other end may be fixed to the fixing member. The fixing member may include a horizontal member and a vertical member, but is not limited thereto, and may have a suitable structure for maintaining the discharge bars to be spaced apart from each other in the precipitation cells.

The insulating unit 33 for insulating the precipitation unit 31 and the discharging unit 32 from each other may be provided, and the insulating unit 33 may form an isolating space. The insulating unit 33 may include an insulating component, such as an insulator, and may be provided in a space separated from the precipitation unit 31 or the discharging unit 32. Such a separated space prevents a gas from flowing from the precipitation unit 31 or the discharging unit 32 to the isolating space by using, for example, a blocking wall or a dividing wall. Here, blocking of a gas is only in a structural level, and not in a strict level.

Referring to 5B, the insulating unit 33 may be formed of a casing 331 that is formed of, for example, a ceramic material, a polymer material, a polypropylene material, or a fiber-reinforced plastic (FRP) material, a resistance reducing device 332 that is accommodated inside the casing 331, and a combined lead 333 combined to the top of the casing 331. The resistance reducing device 332 may reduce overall resistance of the insulating unit 33, and the combined lead 333 may have a structure to which a wire is fixed, wherein the wire is electrically connected to the control module 20 described above. A fixing unit 334, such as a bolt, that fixes the insulating unit 33 to an isolating unit or a fixing plate may be formed below the casing 331, and the combined lead 333 may include a lead 333a, a wire 33b, and a combining protrusion 333c. The wire 333b formed on a top plane of the lead 333a may be induced into the casing 331. The lead 333a may have, for example, a circular plate shape that corresponds to the top portion of the casing 331, and the combining protrusion 333c having a cylindrical shape with a rolled edge may be formed at the bottom of the lead 333a. The lead 333a may be fixed to the top of the casing 331 via, for example, an adhesive or a fixing bolt.

The insulating unit 33 may have any one of various structures, and is not limited.

According to an embodiment of the present invention, the precipitation filter 30 may be connected to and operated by the control module 20.

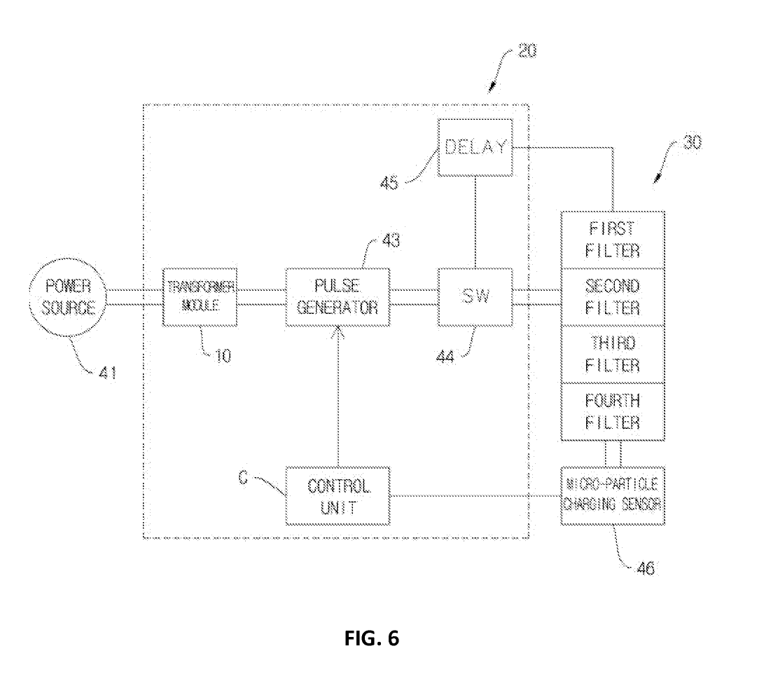

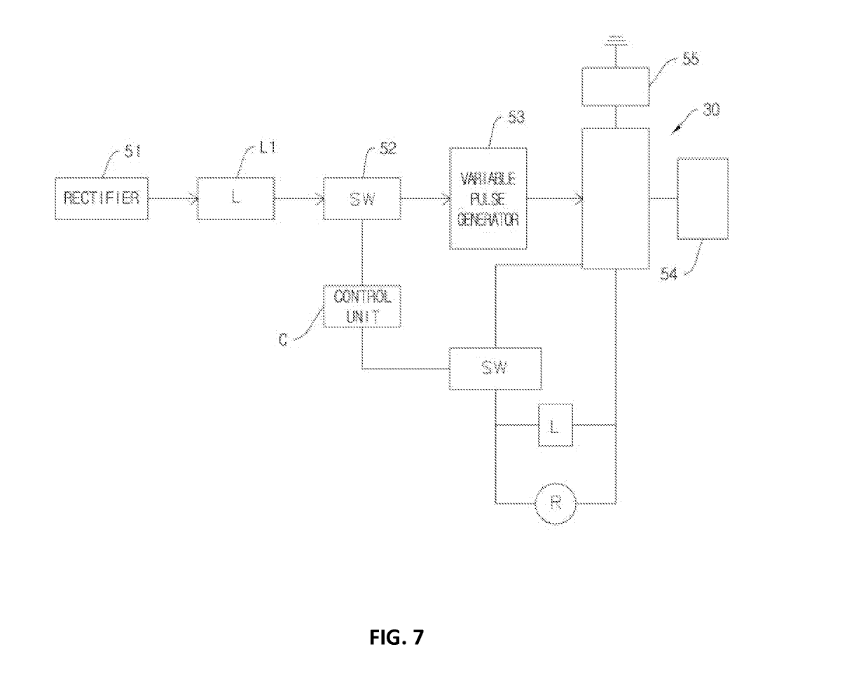

FIGS. 6 and 7 are diagrams for describing an operational structure of a dust collector, according to an embodiment of the present invention.

Referring to FIG. 6, a power source 41, such as an AC power source, may be connected to the transformer module 10, and a pulse high voltage, such as a micro-pulse voltage, generated by a pulse generator 43 may be transmitted to the precipitation filter 30 to operate as a charging voltage. A collecting voltage may be applied by a separate power source or the power source 41. The pulse high voltage generated by the pulse generator 43 may be controlled by a switch unit 44 to be applied to the precipitation filter 30 at regular time intervals. A micro-particle charging sensor 46 may be provided in front of or at the rear of the precipitation filter 30. The micro- particle charging sensor 46 may be provided in front of or at the rear of the precipitation filter 30, and may detect a speed, pressure, or an electrified state of received or discharged micro-particles. A signal detected by the micro-particle charging sensor 46 may be transmitted to a control unit C. The control unit C controls a method of operating the switch unit 44 based on the signal received from the micro-particle charging sensor 46. For example, the switch unit 44 may be connected to a delay unit 45, and the control unit C may set a delay time of the switch unit 44 based on information received from the micro-particle charging sensor 46.

Referring to FIG. 7, the transformer module 10 may include a rectifier 51, and the rectifier 51 may, for example, transmit power to a variable pulse generator 53 through a first power transmitting unit L1. The first power transmitting unit L1 may include an electric device, such as an inductor or a capacitor, and is set to transmit a predetermined amount of power to the variable pulse generator 53. The variable pulse generator 53 may apply a high voltage pulse generated by an operation of a switch unit 52 to the precipitation filter 30. The switch unit 52 may be operated by the control unit C. The variable pulse generator 53 may include, for example, a variable capacitor, and may apply a high voltage pulse having various sizes to the precipitation filter 30.

According to one or more embodiments of the present invention, the precipitation filter 30 may include a resonance circuit of a capacitor and inductor, and a resonance generating cycle may be determined by the micro-particle charging sensor 46. In detail, a collecting electrode of the precipitation filter 30 operates as a capacitor, and an inductor L may be connected to the collecting electrode through a resonance switch SW. The resonance switch SW may be operated by the control unit C. A resonance circuit is formed according to an operation of the resonance switch SW, and a voltage of a discharge electrode may be controlled as, for example, the discharge electrode is connected to a drain circuit 55. As occasion demands, a resistance unit R for determining an initial operational condition of the resonance circuit may be connected to the resonance circuit. A resonance time may be determined by, for example, specific resistance measured by the micro-particle charging sensor 46. As occasion demands, a protection circuit P may be connected to the precipitation filter 30 and prevent a pulse high voltage equal to or higher than a predetermined level from being maintained in the precipitation filter 30. For example, the protection circuit P may be set such that the drain circuit 55 has a uniform voltage level, and the precipitation filter 30 may be connected to the drain circuit 55 so that the precipitation filter 30 is prevented from being maintained in a high voltage state equal to or higher than a certain level for a predetermined time range.

The control module 20 may include any one of various high voltage pulse generating circuits and charging voltage applying circuits, and is not limited by one or more embodiments of the present invention.

As described above, a dust collector according to one or more embodiments of the present invention has a transformer structure that is stable with respect to generation of a high voltage, and thus stably supplies a charging voltage or a collecting voltage. Also, since the dust collector is controlled by a PCB, the dust collector has a structural stability and may be easily controlled. Also, the dust collector increases precipitation performance by applying a micro-pulse voltage while collecting micro-particles having various shapes by applying different types of micro-pulse voltages according to shapes of the micro-particles. In addition, the dust collector may be applied to, for example, a textile factory, a polyvinyl chloride (PVC) factory, a plastic recycling factory, an aluminum recycling factory, a nylon fiber factory, a rubber glove factory, offensive odor treatment in a food factory, a tire factory, or a wallpaper factory. Moreover, the dust collector may be applied to a restaurant where smoke having various smells is generated, such as a restaurant with a grill room, by suitably changing a design of the dust collector.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A dust collector comprising a control module and a precipitation filter, wherein the control module comprises:
a transformer module comprising a core having a pair of magnetic flux paths formed to contact each other, a second coil unit into which one of the pair of magnetic flux paths is inserted, and a first coil unit having a cylindrical shape to accommodate the second coil unit;
a housing having a separated space in which the transformer module is accommodated;
a printed circuit board (PCB) module disposed in another space of the housing; and
a separation plate that separates the transformer module and the PCB module from each other.

2. The dust collector of claim 1, further comprising a pair of terminal units having a curved shape formed at the first coil unit, wherein the pair of terminal units have a wire arrangement structure for accommodation and electric connection of components connected to the pair of terminal units.

3. The dust collector of claim 1, wherein the precipitation filter comprises a resonance circuit and an inductor for operating in a micro-pulse voltage method, and a generating cycle of the resonance is determined by a micro-particle charging sensor, wherein a charging voltage for the resonance circuit is variable.
